(19) United States
(12) Patent Application Publication
(10) Pub. No.: US 2013/0251863 A1
(43) Pub. Date: Sep. 26, 2013

(54) Apparatus for Treating Items with Gas

(71) Applicants: Ahmed Yousef, Columbus, OH (US); Jennifer Perry, Columbus, OH (US); David Kasler, Ashville, OH (US); Sudhir Kartikeya Sastry, Dublin, OH (US)

(72) Inventors: Ahmed Yousef, Columbus, OH (US); Jennifer Perry, Columbus, OH (US); David Kasler, Ashville, OH (US); Sudhir Kartikeya Sastry, Dublin, OH (US)

(73) Assignee: The Ohio State University Research Foundation, Columbus, OH (US)

(21) Appl. No.: 13/425,100

(22) Filed: Mar. 20, 2012

(51) Int. Cl. A23B 5/025; A23B 5/005; F26B 25/06

(52) U.S. Cl. 426/298; 34/201

(57) ABSTRACT

Apparatus for treating items with a treatment gas to decontaminate the items includes a chamber which receives the items. The chamber has a gas inlet in fluid communication with a distribution duct positioned within the chamber. The duct distributes the treatment gas throughout the chamber to prevent gas stratification. The chamber may also have a gas outlet for exhausting the chamber, a treatment gas source providing gas, such as ozone, carbon dioxide, or other treatment gas to the chamber. A vacuum pump is used to lower the pressure within the chamber and a purge pump is used to flush the treatment gas from the chamber upon completion of the treatment. A liquid reservoir is used to maintain a desired humidity within the chamber. A heat exchanger is used to maintain a desired temperature within the chamber, and a fan is used to circulate the treatment gas within the chamber.

### FIELD OF THE INVENTION

This invention relates to an apparatus for treating items, such as foodstuffs, wound dressings, surgical instruments and aseptic containers with a treatment gas to eliminate or render harmless bacterial contaminants.

### BACKGROUND

Bacterial contamination of raw foodstuffs, such as poultry eggs, fresh fruits and vegetables, nuts and legumes presents a widespread health hazard to consumers. As many as 48 million Americans are sickened each year by contaminated food. The hazard is manifest by disease outbreaks costing billions in health care, lost wages, and lost business, not to mention fatalities. For example, even though only a very small percentage (estimated at 1 in 20,000) of raw poultry eggs are contaminated internally with Salmonella Enteritidis, Salmonella transmission through contaminated eggs results in approximately 700,000 cases of salmonellosis at a cost in excess of $1.1 billion annually. Other bacteria, such as Escherichia coli and Listeria monocytogenes account for similar suffering and costs.

Decontamination of foodstuffs is a challenge, as many known methods, while lethal to the bacteria, damage or otherwise render the foodstuffs inedible or undesirable to consumers. The wide range of foodstuffs, as exemplified by poultry eggs, fresh fruits and vegetables, as well as nuts and legumes, with their radically different physical characteristics, each has different requirements for treatments which will effectively eliminate contaminants while preserving the properties of taste, freshness, appearance and transportability which makes the foodstuffs desirable and wholesome. There is clearly a need for an apparatus which can be used to effectively treat different types of foodstuffs against various contaminants using a variety of methods while maintaining the quality and desirability of the foodstuffs to consumers. By virtue of its versatility, such an apparatus would also be useful for sterilizing items such as wound dressings, surgical instruments, aseptic containers or items required to be free of microbial contaminants. Such an apparatus may further be applied to deactivate hazardous toxins, particularly those produced by mold such as alflatoxin, as well as the elimination of pesticide residue.

### SUMMARY

In an example embodiment, an apparatus for treating items with a treatment gas from a source of the gas comprises a chamber adapted to receive the items. The chamber has a gas inlet, the gas inlet being connectable to the source of the treatment gas. A distribution duct is positioned within the chamber. The distribution duct has an intake in fluid communication with the gas inlet and a plurality of openings for distributing the treatment gas throughout the chamber.

In another example embodiment, an apparatus for treating items with a treatment gas comprises a source of the treatment gas and a fluid tight chamber adapted to receive the items. The chamber has a gas inlet, and a gas outlet providing fluid communication between the chamber and the ambient. An inlet duct provides fluid communication between the source of the treatment gas and the gas inlet. An inlet valve is positioned in the inlet duct and controls flow of the treatment gas from the source of the treatment gas to the chamber. A bypass duct provides fluid communication between the gas inlet and the ambient. A first exhaust valve is positioned within the bypass duct for controlling flow of the treatment gas between the inlet duct and the ambient. A bypass valve is in fluid communication with the gas inlet, the inlet duct and the bypass duct. The bypass valve is positioned to control flow of the treatment gas to the chamber, gas destructing unit, or to the ambient through the first exhaust valve. A second exhaust valve is in fluid communication with the gas outlet and controls flow of the treatment gas from the chamber to the ambient. A distribution duct is positioned within the chamber. The distribution duct has an intake in fluid communication with the gas inlet and a plurality of openings for distributing the treatment gas throughout the chamber. A vacuum pump has an intake port in fluid communication with the chamber and an exhaust port in fluid communication with the ambient.

An example apparatus may further comprise a purge pump having an intake port in fluid communication with the ambient and an exhaust port in fluid communication with the chamber.

A reservoir may be positioned within the chamber for holding a liquid, such as water. The reservoir is open for disbursing the liquid throughout the chamber.

In another embodiment, the apparatus includes a reservoir for holding a liquid and a nozzle, in fluid communication with the chamber and the reservoir. The nozzle is for injecting the liquid into the chamber. A control valve is positioned between the reservoir and the nozzle for controlling flow of the liquid to the chamber.

An example apparatus may further include a fan positioned within the chamber for circulating the treatment gas therein.

A heat exchanger may have a heat transfer surface positioned within the chamber for transferring heat between the treatment gas within the chamber and the ambient.

An example apparatus may further comprise a device in fluid communication with the chamber for measuring a concentration of the gas within the chamber.

In practical applications the treatment gas may be selected from the group consisting of ozone, carbon dioxide, chlorine dioxide, ethyleneoxide, propylene oxide, methyl bromide and combinations thereof. The source of the treatment gas may be selected from the group consisting of an ozone generator, a chlorine dioxide generator, or combinations thereof. Further treatment gas sources may be selected from the group consisting of a tank of carbon dioxide, ethylene oxide, propylene oxide, methyl bromide or combinations thereof.

The invention also encompasses a method of decontaminating a plurality of eggs. The method comprises:
subjecting the eggs to a gas pressure less than atmospheric pressure;
subjecting the eggs to ozone at a pressure above atmospheric pressure;
maintaining the eggs at a relative humidity of at least 80% while subjecting the eggs to the ozone.

The eggs may be subjected to a gas pressure less than atmospheric from about 1 to about 29.9 inches Hg vac, with a vacuum of 10-15 inches Hg being advantageous. The eggs may be subjected to the ozone at a pressure from about 3 psig to about 15 psig. Ozone at a pressure of 9-12 psig is advantageous. The eggs may be subjected to the ozone for a duration from about 5 minutes to about 60 minutes. Subjecting the eggs to the ozone for a duration of 25-45 minutes is advantageous. The ozone concentration may be from about 1% wt to about 14% wt, with an ozone concentration of 8-12% wt being advantageous.

It is further found advantageous to we the eggs with water before subjecting the eggs to the gas pressure less than atmospheric pressure. Alternatively, humidity in the treatment chamber may be maintained at 80-100% relative humidity (RH), with RH of 85-95% being advantageous. It is also advantageous to heat the eggs before subjecting the eggs to the gas pressure less than atmospheric pressure. The eggs may be heated to an internal temperature from about 55° C. to about 60° C., with a temperature of about 56-57° C. being advantageous. The egg internal contents may be held at these temperatures for 1-30 minutes with a holding time of 3-15 minutes being advantageous. It is further advantageous to cool the eggs after heating the eggs. The eggs may be cooled to a temperature from about 5° C. to about 30° C., with a temperature of 15-20° C. being advantageous.

### BRIEF DESCRIPTION OF THE DRAWINGS

FIG. 1 is a schematic diagram depicting an example apparatus for treating items with treatment gas.

### DETAILED DESCRIPTION

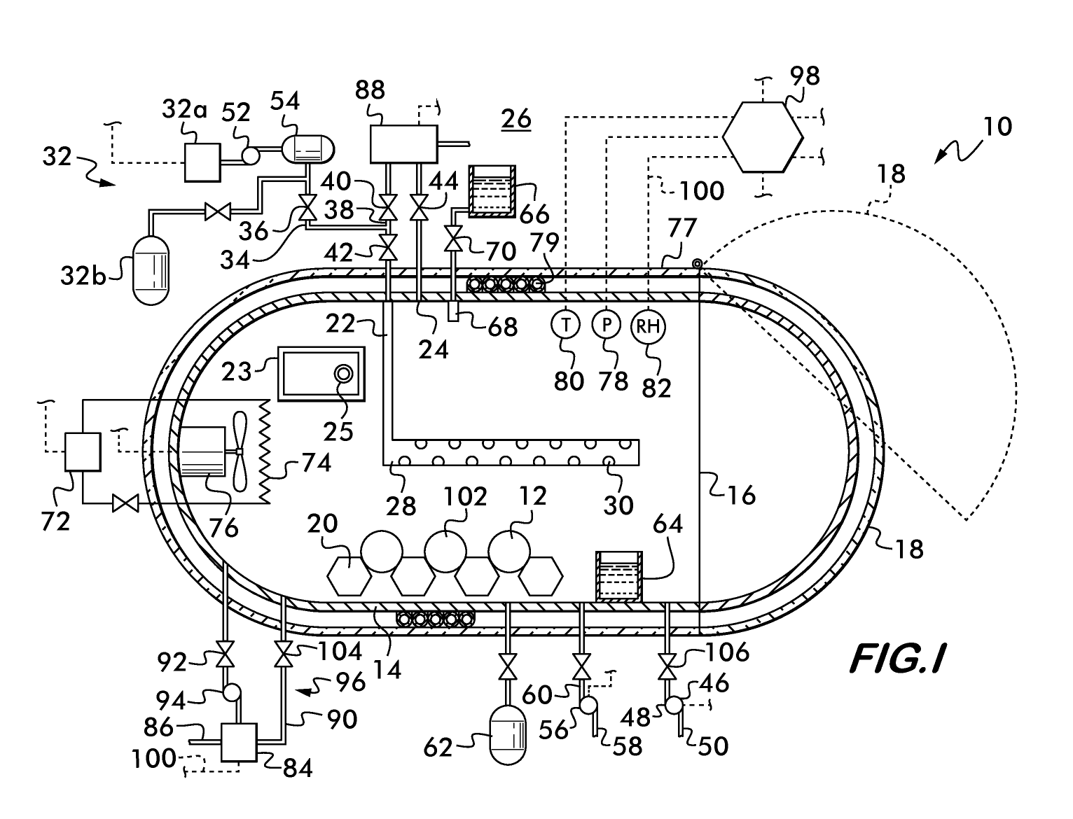

FIG. 1 shows, in schematic form, an example apparatus 10 for treating items 12 with treatment gas. Treatment gas is defined herein to mean a single gas or a mixture of different gases. Apparatus 10 comprises a chamber 14 adapted to receive items 12. Thus, chamber 14 has an opening 16 providing access to the chamber interior for loading and unloading items 12, the opening being closable by a door 18, shown in an open configuration in broken line. Racks 20 or other holding devices may be positioned within the chamber 14 as appropriate for the particular items being treated by the apparatus 10. For some treatments, it is advantageous that the chamber 14 be substantially fluid tight, to allow treatment gas pressures above and below atmospheric to be maintained within the chamber. Furthermore, the shape of such a chamber 14 will be guided by well known engineering principles for pressure vessels, and may result in designs having a cylindrical shape with hemispherical ends. Other shapes are of course feasible and practical, such as flat sided chambers having a rectangular cross section to eliminate dead space within. The chamber material must of course be compatible with the treatment gas so that the chamber is not attacked and corroded by it. Stainless steel alloys, such as SS 316 or better are acceptable for many systems. Similarly, any gaskets or seals must also be compatible with the treatment gas. Rubber is generally avoided as it is susceptible to attack by ozone for example. Gasket materials such as silicone and polytetrafluoroethylene are used to advantage in the apparatus. It is found advantageous to include one or more sealed view ports 23 in the wall of chamber 14. Viewports 23 could be equipped with a camera 25 to document changes in the items 12 as they occur during treatment. The view ports would also admit light into the chamber 14 to permit the photographic recording, for example, still photos, time lapse, or real time video.

Chamber 14 has a gas inlet 22, and may have a separate gas outlet 24 which provides fluid communication between the chamber and the ambient 26 often through a gas destructing unit 88. Destructing unit 88 may be a heater or a furnace which breaks down ozone or other heat-labile gases, a catalyst to catalyze the conversion of the gas to harmless product, a bed of gas-absorbent, or similar products. Gas inlet 22 is in fluid communication with a distribution duct 28 positioned within the chamber 14. Distribution duct 28 extends throughout the chamber 14 and has a plurality of openings 30 for distributing treatment gas therein. The distribution duct 28 avoids stratification of treatment gas which enters chamber 14 through the gas inlet 22 and promotes a substantially homogeneous treatment gas mixture within the chamber. The homogeneous treatment gas mixture ensures that all of the items 12 within the chamber are exposed to the same concentration of treatment gas for effective treatment, regardless of their position within the chamber.

Apparatus 10 may also comprise one or more sources 32 of treatment gas, which may include, for example, an ozone generator 32a, a tank of carbon dioxide 32b and/or other devices or reservoirs capable of providing gas to the chamber 14. An inlet duct 34 provides fluid communication between treatment gas source 32 and the gas inlet 22. An inlet valve 36 may be positioned in the inlet duct 34 between the treatment gas source 32 and the gas inlet 22 to control the flow of treatment gas from the source to the chamber 14. It may also be advantageous to use a bypass duct 38 to provide fluid communication between the gas inlet 22 and the ambient 26. An exhaust valve 40 is positioned within the bypass duct 38 to control treatment gas flow through the bypass duct from the gas inlet 22 to the ambient 26. The treatment gas may pass through the destructing unit 88 before being released to the ambient. A bypass valve 42 is positioned in fluid communication with the gas inlet 22, the inlet duct 34 and the bypass duct 38. The positioning of bypass valve 42 between the gas inlet 22 and both the inlet duct 34 and the bypass duct 38 allows treatment gas from the source 32 to flow either to the gas inlet 22 (and thereby into chamber 14 through distribution duct 28) or to the ambient 26 through the bypass duct 38. Treatment gas flow from source 32 into chamber 14 is enabled by closing the exhaust valve 40 and opening inlet valve 36 and bypass valve 42. Treatment gas from source 32 may be vented to the ambient 26 (again, through destructing unit 88 when necessary) by closing the bypass valve 42 and opening the inlet valve 36 and the exhaust valve 40. Treatment gas venting to the ambient through the destructing unit 88 is useful when the treatment gas source 32 is a device, such as the ozone generator 32a, which may take time to achieve full gas flow rate. Bypass venting of the treatment gas allows full flow rate to be reached before admitting the treatment gas to the chamber 14.

Chamber 14 is advantageously fitted with another exhaust valve 44. Exhaust valve 44 is in fluid communication with the gas outlet 24 and is used to control the flow of treatment gas between the chamber 14 and the ambient 26 through the destructing unit 88. A vacuum pump 46 may be used to evacuate chamber 14 as well as to draw treatment gas into the chamber from the source 32. It is generally advantageous to use oil-less pumps to prevent explosions when highly-reactive gases are used. Vacuum pump 46 has an intake port 48 in fluid communication with chamber 14 and an exhaust port 50 in fluid communication with the ambient 26. Treatment gas pressure within chamber 14 above atmospheric may be achieved and maintained by the action of treatment gas source 32 itself, or by a booster pump 52 in fluid communication with the inlet duct 34 between treatment gas source 32 and gas inlet 22. Additionally, a gas reservoir 54 may be used in conjunction with the inlet duct 34 as an accumulator to provide a flow of treatment gas to the chamber at constant pressure and flow rate if desired.

To rapidly clear the chamber 14 of treatment gas after treatment, a purge pump 56 is used. Purge pump 56 has an intake port 58 in fluid communication with the ambient 26 and an exhaust port 60 in fluid communication with the chamber 14. If ambient air is used as a purge gas, it may be advantageous to filter the air using a HEPA filter for example, so as not to introduce bacteria or other contaminates into the chamber 14. Alternately, chamber 14 may be purged with an inert gas such as nitrogen from a pressurized purge tank 62.

For most gas treatments, it is desirable to control the relative humidity within the chamber 14. To that end, a liquid reservoir 64 may be provided within chamber 14. Reservoir 64 may be, for example, an open container or recess in which water is held, the water evaporating and providing moisture to maintain a desired relative humidity favorable to the gas treatment. To facilitate humidification within chamber 14 it is advantageous to introduce at least a portion of the treatment gas through the water in the reservoir. This humidifies the treatment gas released into the chamber, which in turn, humidifies the chamber. In place of or in addition to the liquid reservoir 64, an external liquid reservoir 66 may be employed. External liquid reservoir 66 may be, for example, a water tank, or the water service of the facility in which the apparatus 10 is located. Water or other liquid from the external reservoir 66 is injected into the chamber 14 using a nozzle 68 in fluid communication with both the chamber 14 and the external reservoir 66. A control valve 70 positioned between the external reservoir 66 and the nozzle 68 may be used to control the flow of liquid to the chamber 14.

It may also be advantageous to control the treatment gas temperature within chamber 14. A heat exchanger 72, operating between the chamber 14 and the ambient 26 may be used to transfer heat to or from the treatment gas and thereby control the temperature within chamber 14. The treatment gas within chamber 14 may be heated or cooled using heat transfer surfaces 74, such as coils through which a heated or chilled working fluid, such as water, propylene glycol or ethylene glycol, flows. Alternately, the heat surfaces could be the coils of a heat pump which uses the Joule-Thompson effect to heat or cool chamber 14. Solid state heating and cooling devices, such as Pelletier devices are also feasible. It may be advantageous to employ a fan 76 within chamber 14 to augment heat transfer by forcing the treatment gas across the heat transfer surfaces 74. Fan 76 would also promote circulation and mixing of the treatment gas within the chamber, preventing stratification and ensuring process uniformity, i.e., all items in the chamber are exposed to an effective concentration of treatment gas. Control of the temperature within chamber 14 may also be effected by providing a layer of insulation 77 surrounding the chamber to reduce heat transfer between the chamber and the ambient 26. Additional temperature control may be afforded by a heating or cooling jacket 79 surrounding the chamber and though which a heating or cooling medium, such as water, glycol, or steam, is circulated.

It is advantageous to measure and monitor various operational parameters of the apparatus 10. The operation parameters of interest include the treatment gas pressure, temperature and relative humidity within chamber 14, as well as the concentration of treatment gases, such as ozone and carbon dioxide used within the chamber, and treatment time. To this end apparatus 10 is equipped with: a pressure transducer 78 for measuring gas pressure within chamber 14; a temperature transducer 80 for measuring the temperature within chamber 14; and a humidity sensor 82 for measuring relative humidity within chamber 14. A treatment gas concentration monitor 84 is used to sample the gas from within chamber 14 and measure the concentration of its constituent gases. The monitor 84 may be used in an open loop configuration 86 to sample and measure small amounts of gas, exhausting the gas sample to the ambient (if environmentally acceptable) or to the destructing unit 88 which treats the treatment gas sample to render it harmless. Monitor 84 may also be used in a closed loop configuration 90, which includes a control valve 92 controlling the flow of gas from the chamber 14 to the monitor 84 and a pump 94 for pumping the gas to the monitor. The monitor 84, pump 94 and valve 92 are in fluid communication with one another and the chamber 14 through piping network 96 which permits gas samples to be drawn from the chamber 14, conducted to the monitor 84 where treatment gas concentration is measured, and then the gas sample is returned to the chamber 14. In an alternate embodiment, a probe may be inserted into chamber 14 to measure treatment gas concentration; this enables the operator to avoid the need to sample the treatment gas.

Apparatus 10 may be automated in its operation through the use of a controller 98, which may comprise, for example, a programmable logic controller or other microprocessor based device. The pressure and temperature transducers 78 and 80, the humidity sensor 82 as well as the treatment gas concentration monitor 84 each generate electrical signals indicative of the respective parameters which they measure and transmit these signals to the controller 98 over a communication network symbolized by dashed lines 100. Lines 100 represent various types of communication means, for example, hard wired electrical conductors as well as wireless radio frequency communication. Resident software within controller 98 interprets the information contained in the signals generated by the transducers, sensors and monitors and uses this information in a feed-back loop to control the operation of the various components of the apparatus 10, such as the various valves, pumps, fan, gas generators and heat exchanger which are also in communication with the controller over communication lines 100. Either fixed orifice or adjustable orifice valves can be used for control of fluid flow coupled with pulsed or analog signals from the controller 98 to maintain less than maximum flow rates for the various valves that may be required during certain phases of the process. Not all of the communication lines are shown in FIG. 1, it being understood that controller 98 may be connected as necessary to any and/or all components as necessary for automated control.

### System Operation

An example of apparatus operation for decontaminating poultry shell eggs is described below, considering that the apparatus 10 may be applied to other items, and that the particular parameters of operation will vary for different items as appropriate.

Eggs 102 are heated in a water bath (not shown) to a temperature of about 56-57° C. (as measured at the yolk) to denature the membrane attached to the inside surface of the egg shell. The eggs 102 are removed from the bath and positioned within chamber 14 while still wet. Door 18 is closed (shown in solid line), and vacuum pump 46 is used to draw a vacuum within chamber 14 that ranges from about 10 inches Hg vac to about 15 inches Hg vac. Application of vacuum allows sufficient water to be drawn out of the shells to prevent subsequent mold growth during product storage. Valve 106 is closed to isolate the vacuum pump 46 from the ambient.

In this example of apparatus operation the eggs 102 are to be decontaminated, both inside and outside their shell, by exposure to ozone. To that end, the treatment gas source 32 is the ozone generator 32a which is activated and begins to produce ozone. During the transient phase of ozone generator operation, the inlet valve 36 is open, the bypass valve 42 is closed and the exhaust valve 40 is open to permit the ozone generator 32 time to reach full ozone flow rate. Once this flow rate is achieved and the eggs have been subjected to vacuum, the exhaust valve 40 is closed, the bypass valve 42 is opened, thereby breaking the vacuum within chamber 14 by permitting ozone to flow into the chamber. Ozone flows through the bypass valve 42 and through the distribution duct 28 which distributes the ozone to all parts of the chamber 14. The distribution duct promotes uniform ozone concentration throughout the chamber and thereby increases the effectiveness of the apparatus.

Ozone within the chamber 14 is maintained at 9-12 psig and a concentration of 8-12% by weight to ensure effective treatment of the eggs. Gas concentration monitor 84 samples the gas from chamber 14, measures the ozone concentration, and signals the controller 98 over communication lines 100, allowing the controller to increase or decrease the ozone concentration by control of the ozone generator 32 as required to maintain the desired concentration. Similarly, the pressure transducer 78 measures the gas pressure within chamber 14 and signals the controller, which increases or decreases the pressure as necessary to maintain the desired pressure. Booster pump 52 may be used in addition to the ozone generator 32 to maintain the desired gas pressure within chamber 14. Temperature transducer 80 measures the temperature within the chamber 14 and signals the controller 98, which activates the heat exchanger 72 to maintain the desired temperature. For egg decontamination using ozone, a temperature from about 15° C. to about 20° C. is desired, and generally the heat exchanger operates to cool the treatment gas within chamber 14 to maintain this temperature. Lower temperatures favor the stability of the ozone, which breaks down and becomes ineffective at higher temperatures. Fan 76 may also be operated as required to promote heat transfer and ensure proper circulation and mixing of the treatment gas for uniform gas concentration and temperature throughout the chamber. Uniform temperature and concentration ensure that all of the eggs are adequately exposed to an effective ozone bath. Water from the liquid reservoir 64 evaporates within the chamber 14 to maintain the desired relative humidity of 85-95%. The high relative humidity increases the antimicrobial effectiveness of the ozone. Should the humidity sensor 82 detect a decrease in the relative humidity its signals to the controller 98 will result in the controller injecting additional water into the chamber 14 from reservoir 66 through nozzle 68 via valve 72. Under the desired conditions of ozone concentration, temperature, pressure and relative humidity prescribed above the eggs will be effectively sanitized after an exposure duration of 25-45 minutes.

After the eggs have been subjected to the ozone bath at the desired concentration of ozone within the desired temperature range, pressure range and humidity range for the desired amount of time, the ozone is vented properly and the eggs may be removed. Removing traces of ozone from the vessel may require flushing vessel contents with ambient air, several times. It is important that ozone level inside the vessel is lower to 0.1 ppm, or less, before the vessel is opened. Valves 92, 104 and 106 are closed to isolate, respectively, the gas concentration monitor 84 and the vacuum pump 46 from the chamber 14. The inlet valve 36 is closed to isolate the ozone generator 32a, and the exhaust valves 40 and 44 are opened to permit treatment gas to escape from chamber 14. The escaping treatment gas, having a high concentration of ozone, is conducted to gas destructing unit 88, in this example a heater, which breaks down the ozone into oxygen and releases it to the ambient 26. Valve 44 can be used to regulate flow of exhaust gases to maintain product quality. Once the pressure within chamber 14 reaches about atmospheric pressure the purge pump 56 is actuated to inject ambient air into the chamber. Chamber pressure is raised and maintained at approximately 3 psig as decrease in treatment gas concentration is measured by the monitor 84. This gas purging step ensures that little, if any ozone remains within the chamber, allowing it to be safely opened for removal of the treated eggs.

### Method of Decontaminating Eggs

The invention also encompasses a method of decontaminating eggs by treating them with ozone. At its core, the method comprises initially subjecting the eggs to gas pressure less than atmospheric, for example, at a vacuum pressure from about 1 inch Hg vac to about 29.9 inches Hg vac. The low pressure of 10-15 inches Hg vac is found to be advantageous. The vacuum pressure is then broken by subjecting the eggs to ozone. In this example method the eggs are subjected to ozone at a pressure from about 3 psig to about 15 psig, with a pressure of 9-12 psig being advantageous. The eggs are subjected to the ozone for a duration from about 5 minutes to about 60 minutes, with a duration of 25-45 minutes being advantageous. The concentration of ozone may be from about 1% by weight to about 14% by weight, with an ozone concentration of 8-12% by weight being advantageous. While subjected to the ozone the eggs are maintained in an environment at a relative humidity of at least 80%, with 80-100% relative humidity being acceptable and 85-95% relative humidity being advantageous.

Other steps may be added to the method. For example, it is advantageous to heat the eggs in a water bath to an internal temperature from about 55° C. to about 60° C. to denature the membranes under the shell. A temperature of 56-57° C. is found effective. This heating step using a water bath also serves to we the eggs, as it is advantageous to subject the eggs to the vacuum while wet. To ensure the effectiveness of the ozone as a decontaminant, it is advantageous to cool the eggs after the heating step. The eggs may be cooled to a temperature from about 5° C. to about 30° C., with a temperature of 15° C. to about 20° C. being effective.

The following examples illustrate use of the method disclosed herein for the decontamination of Salmonella-inoculated shell eggs by heat-ozone combination and compares its effectiveness against other methods of treatment.

Shell eggs were inoculated with Salmonella enterica server Enteritidis to contain 10⁷ colony forming units (cfu)/g of egg contents. Inoculated eggs were exposed to one of the following treatments:

(1) Heating in a circulating water bath and holding egg immersed at 57° C. for 20 minutes.

(2) Heating in the water bath and holding eggs immersed at 57° C. for 20 minutes, followed by a gaseous ozone treatment comprised of applying vacuum at 10 in Hg vac, vessel repressurization to 10 psig with a stream of ozone gas to achieve a concentration of 9% (weight basis), and maintaining the ozone concentration and pressure for 30 minutes.

(3) Heating in the water bath and holding eggs immersed at 57° C. for 25 minutes, followed by a gaseous ozone treatment comprised of applying vacuum at 10 in Hg vac, vessel repressurization to 10 psig with a stream of ozone gas to achieve a concentration of 9% (weight basis), and maintaining the ozone concentration and pressure for 40 minutes.

Surviving Salmonella populations were enumerated by plating egg contents, or their dilutions, onto a selective medium, xylose lysine deoxycholate (XLD) agar. Additionally, a Salmonella detection method (FDA Bacteriological Analytical Manual, BAM; http://www.fda.gov/Food/ScienceResearch/LaboratoryMethods/Bacteri ologicalAnalyticalManualBAM/ucm070149.htm) was carried out when survivors are expected to fall below the detection limit of the enumeration procedure.

### Results

Heating only (treatment 1) produced 4-5 log inactivation of Salmonella in eggs but more than 50% of treated eggs were Salmonella-positive. Mild heating followed by application of ozone (treatment 2) also decreased Salmonella populations by 4-5 log, with more than 50% of the eggs being Salmonella-positive. The combined heat and ozone treatment (treatment 3) totally eliminated Salmonella populations in shell eggs since no survivors grew on the agar medium nor detected by the BAM protocol (e.g., 7-log reduction).

What is claimed is:

1. An apparatus for treating items with a treatment gas from a source of said treatment gas, said apparatus comprising:
a chamber adapted to receive said items, said chamber having a gas inlet, said gas inlet being connectable to said source of said treatment gas;
a distribution duct positioned within said chamber, said distribution duct having an intake in fluid communication with said gas inlet and a plurality of openings for distributing said treatment gas throughout said chamber.

2. The apparatus according to claim 1, further comprising a pump in fluid communication with said chamber for exchanging gases between the ambient and said chamber.

3. The apparatus according to claim 2, wherein said pump comprises a vacuum pump having an intake port in fluid communication with said chamber and an exhaust port in fluid communication with the ambient.

4. The apparatus according to claim 2, wherein said pump comprises a purge pump having an intake port in fluid communication with the ambient and an exhaust port in fluid communication with said chamber.

5. The apparatus according to claim 1, wherein said chamber further comprises a gas outlet providing fluid communication between said chamber and the ambient.

6. The apparatus according to claim 1, further comprising a reservoir positioned within said chamber, said reservoir for holding a liquid.

7. The apparatus according to claim 1, further comprising a reservoir for holding a liquid, said reservoir being in fluid communication with said chamber for releasing said liquid into said chamber.

8. The apparatus according to claim 1, further comprising a fan positioned within said chamber for circulating said treatment gas therein.

9. The apparatus according to claim 1, further comprising a heat exchanger having a heat transfer surface positioned within said chamber for transferring heat between said treatment gas within said chamber and the ambient.

10. The apparatus according to claim 1, further comprising a device in fluid communication with said chamber for measuring a concentration of said treatment gas within said chamber.

11. The apparatus according to claim 1, further comprising a gas destructing unit in fluid communication with said chamber.

12. The apparatus according to claim 11, wherein said gas destructing unit is selected from the group consisting of a heater, a furnace, a catalyst bed and a gas absorbent bed.

13. The apparatus according to claim 1, further comprising a layer of insulation surrounding said chamber.

14. The apparatus according to claim 1, further comprising a heating and cooling jacket surrounding said chamber, said jacket adapted to receive a medium for heating or cooling said chamber.

15. An apparatus for treating items with a treatment gas, said apparatus comprising:
a source of said treatment gas;
a fluid tight chamber adapted to receive said items, said chamber having a gas inlet in fluid communication with said source of said treatment gas and a gas outlet providing fluid communication between said chamber and the ambient;
an inlet valve in fluid communication with said gas inlet and controlling flow of said treatment gas from said source of said treatment gas into said chamber;
an exhaust valve in fluid communication with said gas outlet and controlling flow of said treatment gas from said chamber to the ambient;
a distribution duct positioned within said chamber, said distribution duct having an intake in fluid communication with said gas inlet and a plurality of openings for distributing said treatment gas throughout said chamber;
a vacuum pump having an intake port in fluid communication with said chamber and an exhaust port in fluid communication with the ambient.

16. The apparatus according to claim 15, further comprising a purge pump having an intake port in fluid communication with the ambient and an exhaust port in fluid communication with said chamber.

17. The apparatus according to claim 15, further comprising a reservoir positioned within said chamber for holding a liquid, said reservoir being open for disbursing said liquid throughout said chamber.

18. The apparatus according to claim 15, further comprising:
a reservoir for holding a liquid;
a nozzle in fluid communication with said chamber and said reservoir, said nozzle for injecting said liquid into said chamber;
a control valve positioned between said reservoir and said nozzle for controlling flow of said liquid to said chamber.

19. The apparatus according to claim 15, further comprising a fan positioned within said chamber for circulating said treatment gas therein.

20. The apparatus according to claim 15, further comprising a heat exchanger having a heat transfer surface positioned within said chamber for transferring heat between said treatment gas within said chamber and the ambient.

21. The apparatus according to claim 15, further comprising a device in fluid communication with said chamber for measuring a concentration of said treatment gas within said chamber.

22. The apparatus according to claim 15, wherein said treatment gas is selected from the group consisting of ozone, carbon dioxide, chlorine dioxide, ethylene oxide, propylene oxide, methyl bromide and combinations thereof.

23. The apparatus according to claim 15, wherein said source of said treatment gas is selected from the group consisting of an ozone generator, a chlorine dioxide generator and combinations thereof.

24. The apparatus according to claim 15, wherein said source of said treatment gas is selected from the group consisting of a tank of carbon dioxide, a tank of ethylene oxide, a tank of propylene oxide, a tank of methyl bromide and combinations thereof.

25. An apparatus for treating items with a treatment gas, said apparatus comprising:
a source of said treatment gas;
a fluid tight chamber adapted to receive said items, said chamber having a gas inlet, and a gas outlet providing fluid communication between said chamber and the ambient;
an inlet duct providing fluid communication between said source of said treatment gas and said gas inlet;
an inlet valve positioned in said inlet duct and controlling flow of said treatment gas from said source of said treatment gas to said chamber;
a bypass duct providing fluid communication between said gas inlet and the ambient;
a first exhaust valve positioned within said bypass duct for controlling flow of said treatment gas between said gas inlet and the ambient;
a bypass valve in fluid communication with said gas inlet, said inlet duct and said bypass duct, said bypass valve positioned to control flow of said treatment gas to said chamber, or, to the ambient through said first exhaust valve;
a second exhaust valve in fluid communication with said gas outlet and controlling flow of said treatment gas from said chamber to the ambient;
a distribution duct positioned within said chamber, said distribution duct having an intake in fluid communication with said gas inlet and a plurality of openings for distributing said treatment gas throughout said chamber;
a vacuum pump having an intake port in fluid communication with said chamber and an exhaust port in fluid communication with the ambient.

26. The apparatus according to claim 25, further comprising a purge pump having an intake port in fluid communication with the ambient and an exhaust port in fluid communication with said chamber.

27. The apparatus according to claim 25, further comprising a reservoir positioned within said chamber for holding a liquid, said reservoir being open for disbursing said liquid throughout said chamber.

28. The apparatus according to claim 25, further comprising:
a reservoir for holding a liquid;
a nozzle in fluid communication with said chamber and said reservoir, said nozzle for injecting said liquid into said chamber;
a control valve positioned between said reservoir and said nozzle for controlling flow of said liquid to said chamber.

29. The apparatus according to claim 25, further comprising a fan positioned within said chamber for circulating said treatment gas therein.

30. The apparatus according to claim 25, further comprising a heat exchanger having a heat transfer surface positioned within said chamber for transferring heat between said treatment gas within said chamber and the ambient.

31. The apparatus according to claim 25, further comprising a device in fluid communication with said chamber for measuring a concentration of said treatment gas within said chamber.

32. The apparatus according to claim 25, wherein said treatment gas is selected from the group consisting of ozone, carbon dioxide, and combinations thereof.

33. The apparatus according to claim 25, wherein said source of said treatment gas comprises an ozone generator.

34. The apparatus according to claim 25, wherein said source of said treatment gas comprises a tank of carbon dioxide.

35. A method of decontaminating a plurality of eggs, said method comprising:
subjecting said eggs to a gas pressure less than atmospheric pressure;
subjecting said eggs to ozone at a pressure above atmospheric pressure;
maintaining said eggs at a relative humidity of at least 80% while subjecting said eggs to said ozone.

36. The method according to claim 35, comprising subjecting said eggs to a gas pressure less than atmospheric from about 1 to about 29.9 inches Hg vac.

37. The method according to claim 35, comprising subjecting said eggs to a gas pressure less than atmospheric of about 10-15 inches Hg vac.

38. The method according to claim 35, comprising subjecting said eggs to said ozone at a pressure from about 3 psig to about 15 psig.

39. The method according to claim 35, comprising subjecting said eggs to said ozone at a pressure of about 9-12 psig.

40. The method according to claim 35, comprising subjecting said eggs to said ozone for a duration from about 5 minutes to about 60 minutes.

41. The method according to claim 35, comprising subjecting said eggs to said ozone for a duration of about 25 minutes to about 45 minutes.

42. The method according to claim 35, comprising subjecting said eggs to said ozone at a concentration from about 1% wt to about 14% wt.

43. The method according to claim 35, comprising subjecting said eggs to said ozone at a concentration of about 8% wt to about 12% wt.

44. The method according to claim 35, further comprising wetting said eggs with water before subjecting said eggs to said gas pressure less than atmospheric pressure.

45. The method according to claim 35, further comprising heating said eggs before subjecting said eggs to said gas pressure less than atmospheric pressure.

46. The method according to claim 45, further comprising heating said eggs to a temperature from about 55° C. to about 60° C.

47. The method according to claim 45, further comprising heating said eggs to a temperature of about 56° C. to about 57° C.

48. The method according to claim 35, further comprising cooling said eggs after heating said eggs.

49. The method according to claim 48, further comprising cooling said eggs to a temperature from about 5° C. to about 30° C.

50. The method according to claim 48, further comprising cooling said eggs to a temperature of about 15° C. to about 20° C.
